(19) United States
(12) Patent Application Publication
(10) Pub. No.: US 2016/0073719 A1
(43) Pub. Date: Mar. 17, 2016

(54) MASK FOR A DOLL

(71) Applicant: Possibility Place LLC, St. Louis, MO (US)

(72) Inventor: Jill E. Barad, Los Angeles, CA (US)

(21) Appl. No.: 14/834,421

(22) Filed: Aug. 24, 2015

Related U.S. Application Data
(60) Provisional application No. 62/049,344, filed on Sep. 11, 2014.

(51) Int. Cl. A41G 7/02; G06F 17/50; A63H 3/36

(52) U.S. Cl. CPC A41G 7/02; A63H 3/365; G06F 17/50

(57) ABSTRACT

A mask adapted to be installed over the existing face of a doll having projecting facial features to change the appearance of the doll's face includes a front surface configured to represent the face of a particular individual and a rear surface configured to overlie the existing face of the doll, and receive at least some of the projecting facial features of the doll. The mask has a perimeter edge, at least a portion of which abuts at least one projecting features on the existing face of the doll.

A computer implemented method of making the includes accepting a user selection of one of a plurality of dolls; processing three dimensional image data of the face of the particular individual; and combining the processed three-dimensional image data with a template corresponding to doll selected by the user to create a three dimensional mask data set. This three-dimensional mask data set can be printed on a 3-D printer to make a three dimensional mask for the selected doll.

### CROSS-REFERENCED APPLICATION

This application claims priority to U.S. provisional application Ser. No. 62/049,344 filed on Sep. 11, 2014. The disclosure of the above-referenced application is incorporated herein by reference in its entirety.

### BACKGROUND

This invention relates to masks for dolls, and in particular to masks customized to a particular person's facial features in order to make a doll look like the particular individual.

Dolls are among the oldest yet still the most popular children's toys. A highly popular category of dolls are fashion dolls which children can dress up and imagine themselves in a wide range of situations. A classic example of this category is the Barbie® doll, introduced in 1959 and which has annual sales in excess of one billion dollars. There are numerous other fashion dolls, with different sizes and a proportion, but a common feature is that they provide a vehicle in which children can project themselves into other times and places.

In many cases it would enhance the play value if the child could customize a familiar doll with the child's own facial features. However for most a customized doll in prohibitively expensive.

### SUMMARY

Embodiments of the present invention provide a mask adapted to be installed over the existing face of a doll having projecting facial features to change the appearance of the doll's face. A preferred embodiment of such a mask comprises a front surface configured to represent the face of a particular individual; and a rear surface configured to overlie the existing face of the doll, and receive at least some of the projecting facial features of the doll. The mask has perimeter edge, at least a portion of which abuts at least one of the projecting features on the existing face of the doll.

The front surface of the mask preferably has at least one three dimensional facial feature that is based upon a three dimensional image of the particular individual, and more preferably there are at least two three dimensional facial features based upon a three dimensional image of the particular individual. At least two of the three dimensional facial features are scaled differently.

Embodiments of this invention also include a computer implemented method of making a mask to be installed over the existing face of a doll. A preferred embodiment of which comprises accepting a user selection of one of a plurality of dolls, processing three dimensional image data of the face of the particular individual, and combining the processed three-dimensional image data with a template corresponding to doll selected by the user to create a three dimensional mask data set. The three-dimensional mask data set can be printed to make a three dimensional mask for the selected doll.

The step of processing three dimensional image data of the face of the particular individual preferably comprises differentially scaling the image in at least two directions, to accommodate the proportions of the doll head. The step of processing three dimensional image data of the face of the particular individual preferably alternatively or additionally comprises differentially scaling the image in at least two directions according to predetermined ratios corresponding to the selected doll, to accommodate the proportions of the doll head.

### DRAWINGS

FIG. 1 is an image of a first embodiment of a customized mask for a conventional Barbie® doll, in accordance with the principles of this invention;

FIG. 2 is a photograph of a girl on which the mask in FIG. 1 is based;

FIGS. 3-5 are front elevation views of a conventional Barbie® doll as the mask of FIG. 1 is being installed thereon;

FIG. 6A is a front elevation view of a conventional Barbie® doll with the mask of FIG. 1 installed thereon;

FIG. 6B is a front elevation view of the conventional Barbie® doll before the installation of the mask of FIG. 1;

FIG. 7 is an enlarged front elevation view of the face of the conventional Barbie® doll showing some of the locations and dimensions that can be used to scale real face image data to make a mask for a doll that is consistent with the look of the doll;

FIG. 8 is a front elevation view of a second embodiment of a customized mask for a conventional Barbie® doll, in accordance with the principles of this invention;

FIG. 9 is a left side perspective view of the mask in FIG. 8;

FIG. 10 is a right side perspective view of the mask in FIG. 8;

FIG. 11A is a side elevation view of a conventional Barbie® doll;

FIG. 11B is a side elevation view of a conventional Barbie® doll, with the mask of FIG. 8;

FIG. 12 is an enlarged front elevation view of the face of a conventional American Girl® doll showing some of the locations and dimensions that can be used to scale real face image data to make a mask for a doll that is consistent with the look of the doll;

FIG. 13 is a front elevation view of a customized mask for the American Girl® doll shown in FIG. 12;

FIG. 14 is a front elevation view of the face of a conventional American Girl® doll;

FIGS. 15 A-C are side views of the American Girl® doll, showing the mask being installed over the face;

FIG. 16 is a front elevation view of the mask and the American Girl® doll;

FIG. 17 is a front elevation view of the mask being installed over the face of the American Girl® doll;

FIG. 18 is a front elevation view of the mask being installed over the face of the American Girl® doll;

FIG. 19 is a is a front elevation view of the American Girl® doll with the mask covering the face;

FIG. 20 is a flow chart of the process of making a doll mask.

### DETAILED DESCRIPTION

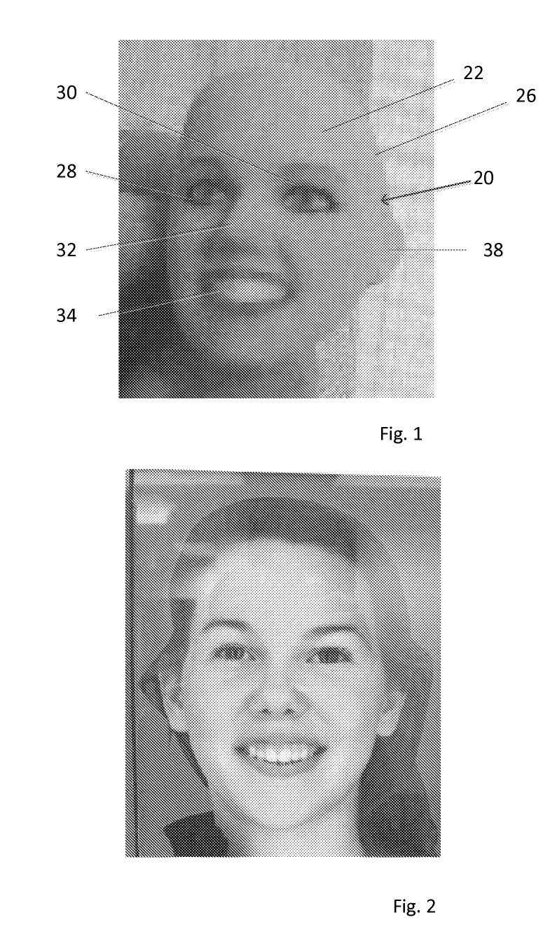

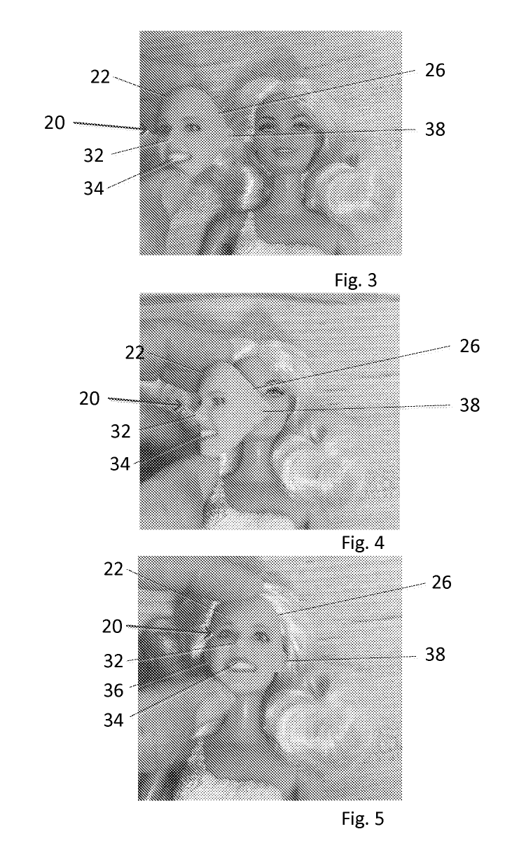

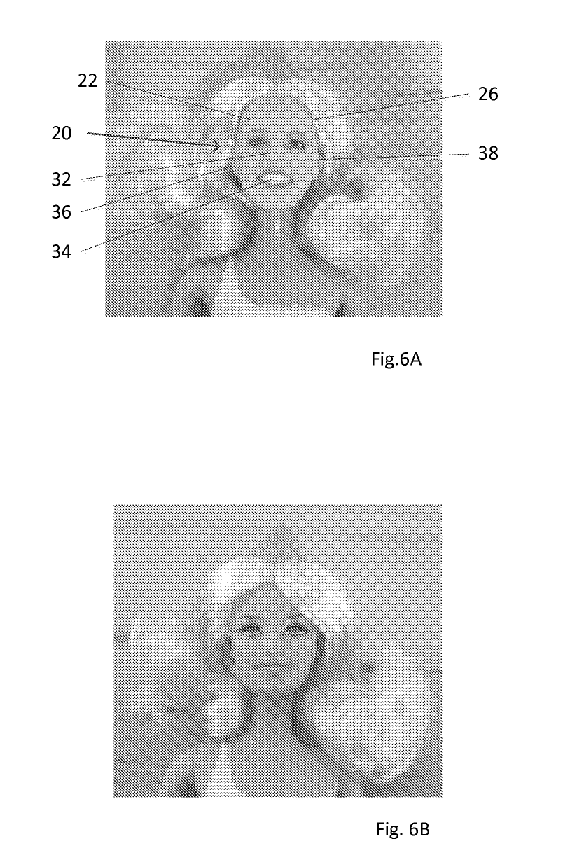

A preferred embodiment of a mask adapted to be installed over the existing face of a doll having projecting facial features to change the appearance of the doll's face is indicated generally as 20 in FIG. 1. The mask 20 comprises a front surface 22 configured to represent the face of a particular individual. The mask 20 also comprises a rear surface 24 configured to overlie the existing face F of the doll D, and receive at least some of the projecting facial features of the doll. The rear surface 24 is preferably configured closely match the facial features of the doll so that the mask can be made thin to unobtrusively fit over the face of the doll. Moreover, a close fit between the face of the doll and the rear surface 24 of the mask can help secure the mask 20 over the face of the doll. The mask 20 has perimeter edge 26, at least a portion of which abuts at least one projecting features on the existing face of the doll.

The front surface 22 of the mask 20 has at least one three dimensional facial feature based upon a three dimensional image of the particular individual (FIG. 2). The front surface 22 preferably has at least two three dimensional facial features based upon the three dimensional image of the particular individual. For example the mask preferably includes eyes 28 and 30, a nose 32 and a mouth 34. Some embodiments may also include ears 36, 38.

While the facial features are based upon the facial features in the three-dimensional image data of the particular individual. The individual features are preferably individually scaled based upon the particular doll for which the mask is being made, For example in one type of doll, the size of the eyes may be exaggerated (e.g., 50% larger) compared with the other facial features. If a mask for such a doll did not have a similar scaling the mask would not look right. Thus each of the individual facial features from the three dimensional data set are preferably individual scaled according to the particular scaling of existing features on the doll for which the mask is being made. Depending on the doll, typically at least two facial features will be differentially scaled, but for highly stylized dolls all three features (i.e., the eyes, the nose, and the mouth) may be differently scaled.

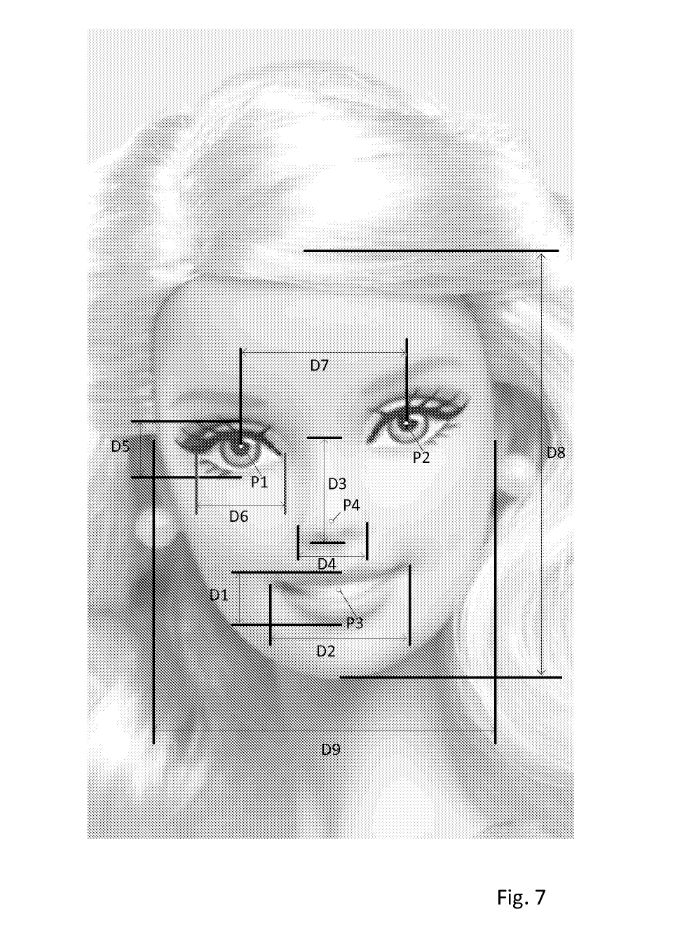

As shown in FIG. 7, a particular doll may have any number of dimensions and ratios of the various facial features displayed, including:

| Label in FIG. 1 | Description |
|---|---|
| D1 | Mouth height |
| D2 | Mouth width |
| D3 | Nose height |
| D4 | Nose width |
| D5 | Eye height |
| D6 | Eye width |
| D7 | Distance between |
| | centers of eyes |
| D8 | Face height |
| D9 | Face width |
| P1 | Center of right eye |
| P2 | Center of left eye |
| P3 | Center of mouth |
| P4 | Tip of nose |

These features and others may be differentially sized and or scaled in accordance with the size and scaling of the doll for which the mask that is being made. Thus if a mask resembling one person is being made for two different dolls, the sizes, proportions, and positions of that person's facial features might be different on each of the masks to conform to the design and aesthetic of the doll for which the mask is being made.

Alternatively, or in addition to scaling individual features, the overall all image data can be differentially scaled in one more directions. For example, some dolls might have an elongated head (as compared with typical human proportions), other dolls might have a wider head (as compared with typical human proportions). The three dimensional image data can be differentially scaled for a mask to fit a longer doll face or a wider doll face.

The rear surface 24 is configured to overlie the existing face F of the doll D, and has recesses configured to receive at least some of the existing projecting facial features of the doll D. The heads of some dolls have a configuration, such that a mask can engage the head of the doll with an interference fit, the doll head or the mask, or both flexing so that the mask can be installed and removed from the doll head.

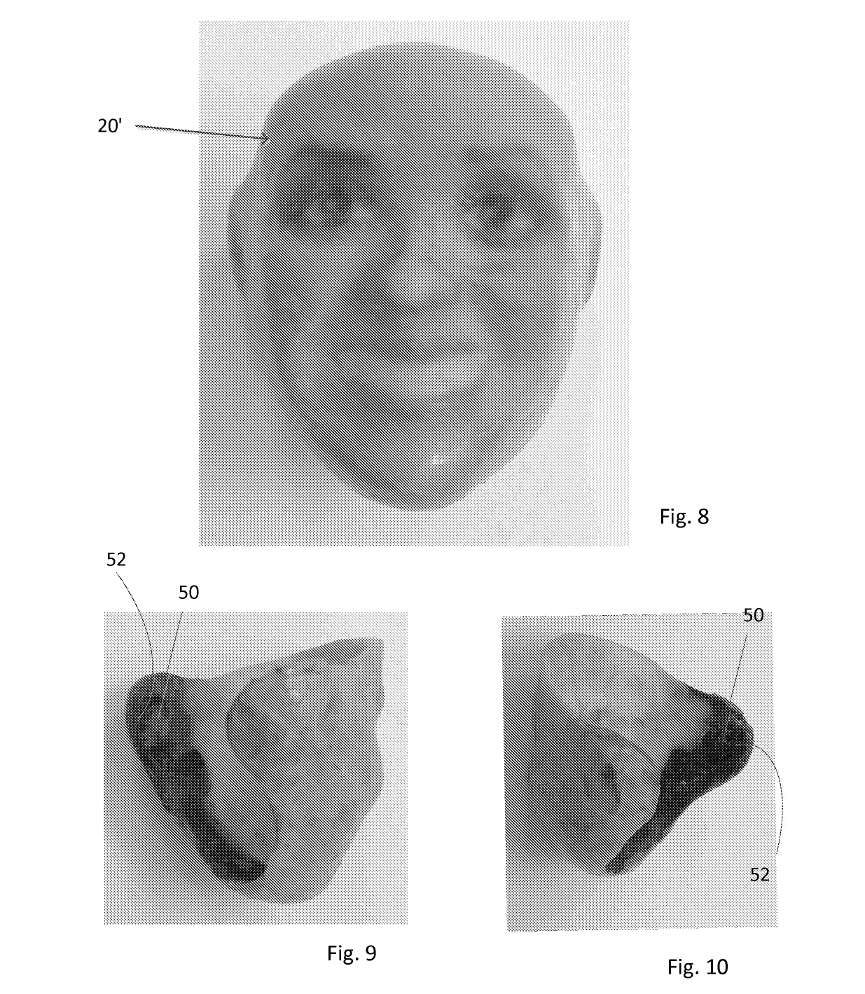

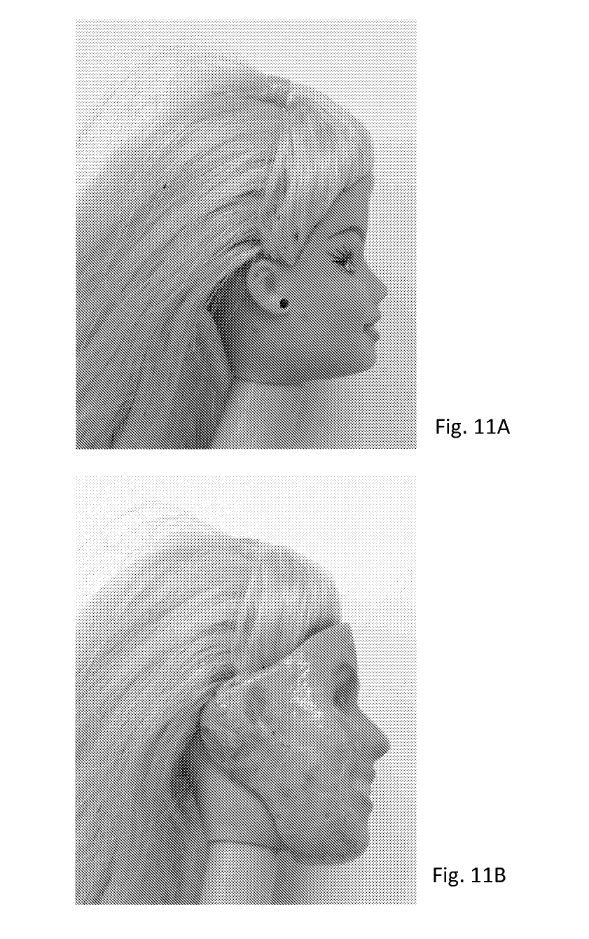

For example, in some embodiments the mask, such as the mask 20′ in FIGS. 8-11, the rear surface of 24 of the mask 20′ has recesses 50 to receive the ears 36, 38 of the doll, with a perimeter edge 52l that engages a projecting portion of the ears on the doll to secure the mask.

Some doll heads are not configured to permit a mask to be conveniently interference fit thereon. In these cases, one or more adherent elements 40 can be provided on the rear surface 24. These adherent elements 40 may be patches of adhesive or patches of a gel that allow the mask 20 to be temporarily secured on the head of the doll.

To disguise the perimeter edges 26 of the mask 20, it is desirable that at least some of the perimeter edges of the mask abuts projecting features on the existing face of the doll. For example, at the top, and along the upper side edges of the mask, the edges abut the hairline of the doll head; the side edges can either abut the hairline, or abut the doll's ears. Finally the lower edges of the mask can abut the underside of the chin, or more preferably the front of the neck.

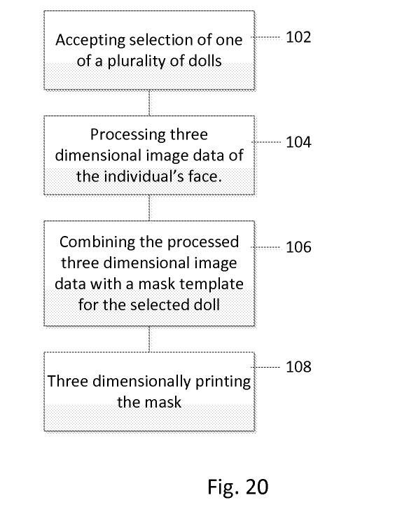

According to another aspect of this invention, a method of making a mask to be installed over the existing face of a doll having projecting facial features to make the doll resemble a particular individual, is provided. This method is shown schematically in FIG. 20. In a preferred embodiment, the method comprises at 102 accepting a user selection of one of a plurality of dolls. This can be implemented by providing a pick-list of dolls for which masks can be created. Then, at 104, processing three dimensional image data of the face of the particular individual. This data can come from two or more two-dimensional images of the individual's face from different perspectives, or it could a three dimensional image data set. The processing includes scaling the image of the individual's face to the correct size and aspect ratio (height to width) for the mask. At 106 the processed three-dimensional image data is combined with a template corresponding to doll selected by the user to create a three dimensional mask data set. At 108, the three-dimensional mask data set is printed to make a three dimensional mask for the selected doll.

The step 104 of processing three dimensional image data of the face of the particular individual preferably comprises differentially scaling the image in at least two directions, i.e. making the face narrower or wider or shorter or longer to fit on the mask template. For example if the user's face had a face length to face width ratio of 1.3, and the mask template for the particular doll had a face length to face ratio of 1.2, the image data would be adjusted to to either decrease the length or increase the width.

The step 104 of processing three dimensional image data of the face of the particular individual preferably also includes differentially scaling data corresponding to at least two facial features. For example if a particular doll is stylized so that the eyes are 50% bigger relative to other facial features compared with typical anatomy, the image data of the face of the particular individual would be processed to increase the size of the eyes relative to the other facial features. This differential scaling helps ensure that the mask “looks right” on the doll.

The step 104 of processing three dimensional image data of the face of the particular individual preferably can include differentially scaling data corresponding to at least two facial features according to predetermined ratios corresponding to the selected doll. For example, if a particular doll has features in which the eyes and mouth are large compared with typical anatomy and the nose is small compared with typical anatomy, then these features can be scaled according to a predetermined ratio for that particular doll.

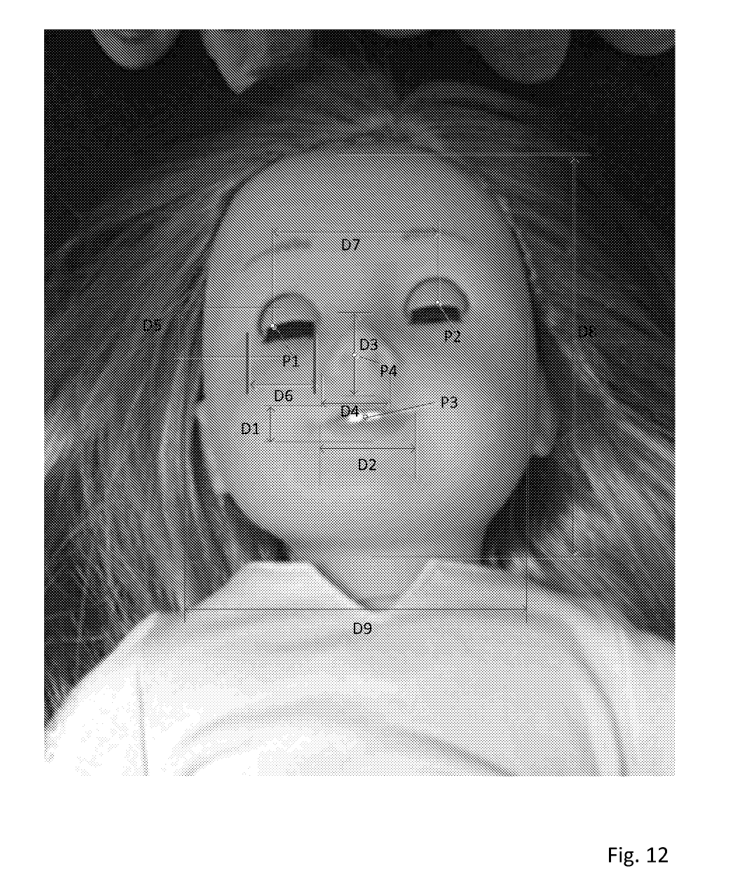

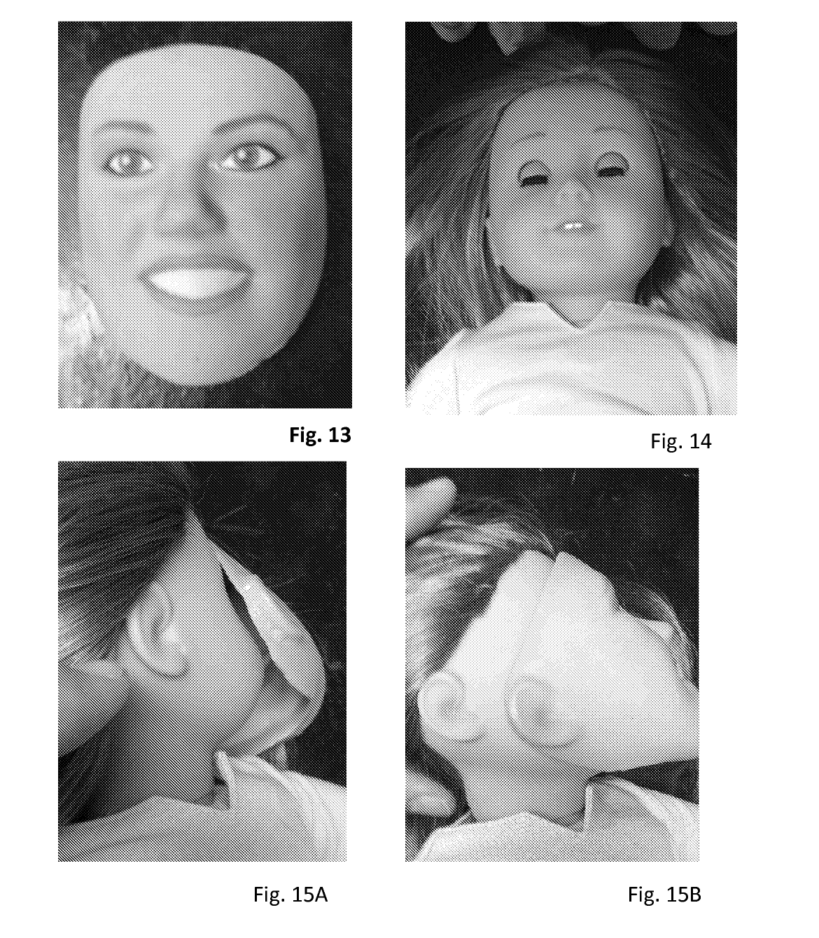

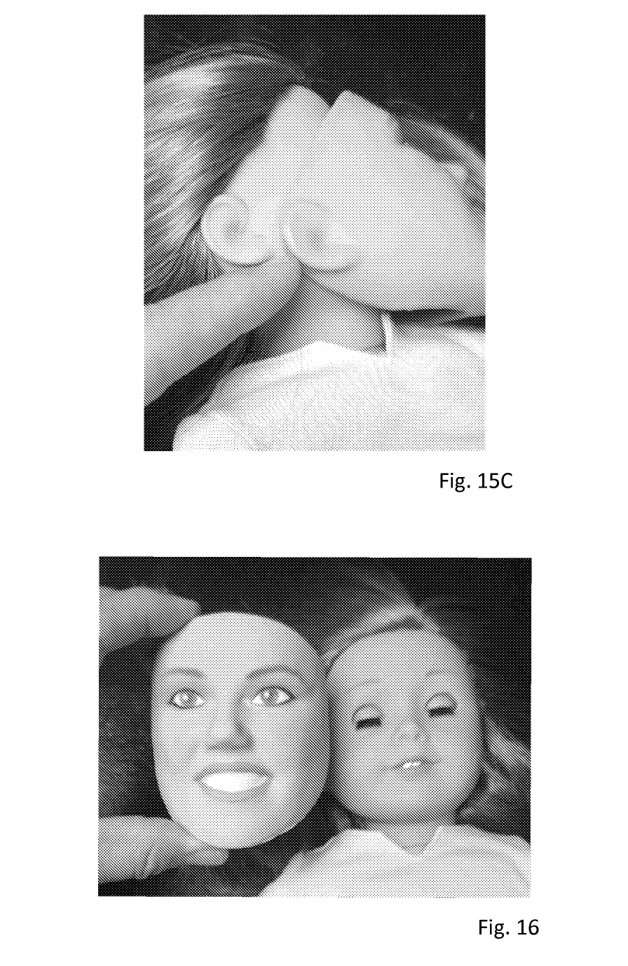

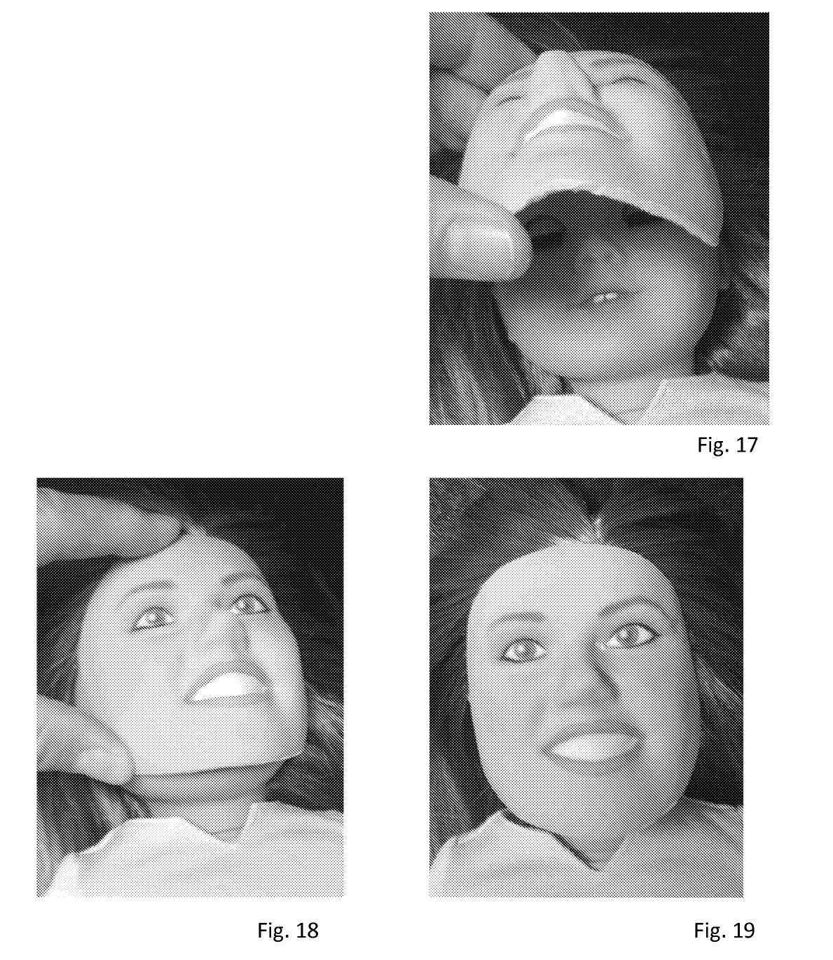

Another preferred embodiment of a mask constructed according to the principles of this invention is indicated generally as 20″ in FIGS. 12-19. As shown in FIG. 12 various points and dimensions on this doll correspond to the points and dimensions identified above with respect to FIG. 7. The mask 20″ comprises a front surface 22 configured to represent the face of a particular individual. The mask 20″ also comprises a rear surface 24 configured to overlie the existing face F of the doll D, and receive at least some of the projecting facial features of the doll. The rear surface 24 is preferably configured closely match the facial features of the doll so that the mask can be made thin to unobtrusively fit over the face of the doll. Moreover, a close fit between the face of the doll and the rear surface 24 of the mask can help secure the mask 20 over the face of the doll. The mask 20 has perimeter edge 26, at least a portion of which abuts at least one projecting features on the existing face of the doll.

The front surface 22 of the mask 20 has at least one three dimensional facial feature based upon a three dimensional image of the particular individual (e.g. the face shown in FIG. 2). The front surface 22 preferably has at least two three dimensional facial features based upon the three dimensional image of the particular individual. For example the mask preferably includes eyes 28 and 30, a nose 32 and a mouth 34. Some embodiments may also include ears 36, 38.

While the facial features are based upon the facial features in the three-dimensional image data of the particular individual. The individual features are preferably individually scaled based upon the particular doll for which the mask is being made. Thus, although the mask 20″ for the doll in FIGS. 12-19 is of the same face as the mask 20 and 20′, the scaling of the individual facial feature, and their relative locations are different so that while the mask is customized to a particular individual, the mask still look appropriate for the doll on which it is intended to be placed.

What is claimed is:

1. A mask adapted to be installed over the existing face of a doll having projecting facial features to change the appearance of the doll's face, the mask comprising:
a front surface configured to represent the face of a particular individual; and
a rear surface configured to overlie the existing face of the doll, and receive at least some of the projecting facial features of the doll;
the mask having perimeter edge, at least a portion of which abuts at least one projecting features on the existing face of the doll.

2. The mask according to claim 1 wherein the front surface of the mask has at least one three dimensional facial features based upon a three dimensional image of the particular individual.

3. The mask according to claim 2 wherein there are at least two three dimensional facial features based upon a three dimensional image of the particular individual.

4. The mask according to claim 3 wherein there are at least two three dimensional facial features based upon a three dimensional image of the particular individual, and wherein at least two of the three dimensional facial features based upon a three dimensional image of the particular individual are scaled differently.

5. A computer implemented method of making a mask to be installed over the existing face of a doll having projecting facial features to make the doll resemble a particular individual, the method comprising:
accepting a user selection of one of a plurality of dolls;
processing three dimensional image data of the face of the particular individual; and
combining the processed three-dimensional image data with a template corresponding to doll selected by the user to create a three dimensional mask data set;
printing the three-dimensional mask data set to make a three dimensional mask for the selected doll.

6. The computer implemented method of making a mask according to claim 5, wherein the step of processing three dimensional image data of the face of the particular individual comprises differentially scaling the image in at least two directions.

7. The computer implemented method of making a mask according to claim 5, wherein the step of processing three dimensional image data of the face of the particular individual comprises differentially scaling the image in at least two directions according to predetermined ratios corresponding to the selected doll.

8. The computer implemented method of making a mask according to claim 5, wherein the step of processing three dimensional image data of the face of the particular individual comprises differentially scaling data corresponding to at least two facial features.

9. The computer implemented method of making a mask according to claim 5, wherein the step of processing three dimensional image data of the face of the particular individual comprises differentially scaling data corresponding to at least two facial features according to predetermined ratios corresponding to the selected doll.
